(19) United States
(12) Patent Application Publication
(10) Pub. No.: US 2014/0295373 A1
(43) Pub. Date: Oct. 2, 2014

(54) DEVICE FOR TREATING GINGIVA/ MUCOSA AT TEETH OR IMPLANTS

(71) Applicant: UNIVERSITAET BERN, Bern (CH)

(72) Inventors: Urs Braegger, Neuenegg (CH); Michel Gigandet, Worb (CH); Jan Vizek, Bern (CH); Ulrich Hegnauer, Ruedtligen (CH); Kurt Flury, Bremgarten (CH)

(21) Appl. No.: 14/353,480

(22) PCT Filed: Oct. 5, 2012
(86) PCT No.: PCT/EP2012/069712

§ 371 Date: Apr. 22, 2014

(30) Foreign Application Priority Data
Oct. 25, 2011 (EP) 11405344.0

(51) Int. Cl. A61C 17/16; A61C 1/07; A61C 19/06

(52) U.S. Cl. CPC A61C 17/16; A61C 19/063; A61C 1/07
USPC 433/82

(57) ABSTRACT

A device for “treating” gingiva/mucosa at teeth/implants comprises at least one segment comprising a contour surface formed according to an individual geometry of a patient's dentition for closely contacting a region of an outer surface of a tooth and an adjacent region of a gingiva, whereas the regions in particular include a sulcus region, a storage and/or supply for a composition including a cleaning agent, a remineralizing composition, and/or a pharmaceutical composition to be applied to the regions of the tooth and the gingiva and a transmission element for transmitting vibrations to the at least one segment.

### TECHNICAL FIELD

The invention relates to a device for treating gingiva/mucosa at teeth/implant.

### BACKGROUND ART

Dental restorations on teeth or on implants such as crowns or fixed dental prostheses are known for a long time. In case of insufficient care, the patient having dental restorations on teeth and/or implants bears a certain risk of long-term complications such as secondary caries, periodontitis or periimplantitis. Especially the transition region from the teeth to the gingiva, including the sulcus, and from the implants to the mucosa is often not adequately cared for.

Usual means for the cleaning of teeth comprise (mechanical or electrical) toothbrushes, dental floss or interdental brushes. In principle, used correctly they allow in most cases for an adequate care for the natural and artificial teeth as well as for the gingiva/mucosa. However, correct use means the application of the right force in connection with the right movements of the mechanical devices for a sufficient time. Due to limited access, negligence, poor training or personal impairments in many cases the care is not adequate despite the availability of the mentioned devices.

Therefore, several attempts have been made to improve the situation.

DE 10 2005 052 607 A1 (J. Charlot) discloses a device for cleaning teeth comprising a cap containing a cleaning body. In order to clean interdental spaces the device further comprises elastic cleaning rods that are arranged perpendicular to and between lateral walls of the cap. The cleaning body consists of a porous material that absorbs a cleaning fluid comprising compositions that have disinfecting as well as deodorizing properties, which are activated by saliva in connection with body temperature. Furthermore, the porous material is elastic such that it contacts essentially the full outer surface of teeth penetrating the material.

Use of this device is rather cumbersome, mainly because of the cleaning rods that have to be pushed into the interdental spaces after placement of the cleaning body.

U.S. Pat. No. 3,069,935 (R. H. Riddell) relates to a jacket device having a form that follows the general contour of a person's jaw-bones and having a H-shape in cross-section to form a through for both the lower as well as the upper jaw. The depth of the troughs is such that the exposed crowns of the teeth as well as the gums are accommodated. The jacket comprises a central sponge-like core, e. g. made from sponge polyurethane, faced about the entire perimeter by a coating composed of a material impermeable to liquid. A tube to draw saliva from within the mouth extends through the jacket, its outer end projecting beyond the front face of the jacket in order to accommodate attachment of a suction hose. A solution the patient's teeth and gums are to be treated with is applied to the core, the device is introduced into the mouth. Subsequently, the patient applies biting pressure forcing the solution into intimate contact with the teeth and gums.

The device is aimed to be used by dentists. Its use will be occasional.

WO 2006/119855 A1 (K. Teichert, E. Grandy) relates to a process and a device for cleaning teeth with sonic energy. Sound is applied from the outside of the oral cavity and conducted to the teeth through a liquid in the oral cavity, e. g. water or an aqueous solution. The device comprises an application head which is adapted to the outside of the oral cavity in order to transmit the sonic energy over a large surface. A gel may be provided in between the application head and the outside of the oral cavity in order to improve transmission. Using the disclosed method and device direct contact of a device with the teeth to be cleaned is avoided.

Due to the fact that the liquid distributes the sonic energy simultaneously to all teeth within the oral cavity, there is essentially no control about the characteristics (e. g. vibrational plane) and the amplitude of vibrations acting onto specific regions of the dentition. Correspondingly, it cannot be ensured that the described device optimally cleans all regions of a dentition.

In addition to the disadvantages mentioned above, no results of clinical studies showing the ability of such prior art devices to remove dental plaque have ever been published.

### SUMMARY OF THE INVENTION

It is the object of the invention to create a device pertaining to the technical field initially mentioned, that allows for the easy and systematic treatment of gingiva or mucosa and natural and/or artificial teeth leading to satisfactory cleaning results.

The solution of the invention is specified by the features of claim 1. According to the invention, the device comprises
a) at least one segment comprising a contour surface formed according to an individual geometry of a patient's dentition for closely matching a region of an outer surface of a tooth and an adjacent region of a gingiva or mucosa, whereas the regions in particular include a sulcus region;
b) a storage and/or supply for a composition including a cleaning agent, a remineralizing composition, and/or a pharmaceutical composition to be applied to the regions of the tooth and the gingiva/mucosa;
c) a transmission element for transmitting vibrations to the at least one segment.

In use, the vibrations transmitted to the segment will be further transmitted to the region of the outer surface of the tooth and the adjacent region of the gingiva or mucosa closely matched by the contour surface of the segment. This further transmission may be effected by direct contact between the segment and the mentioned region, but preferably the vibrations will be transmitted to the region via the composition (e. g. a fluid, pasty or gel-like medium). For this purpose, there will be a small void (preferably having a width of 0.2-0.6 mm) between the contour surface and the surface region to be treated, filled by the composition, whereas the composition propagates the vibration from the segment to the surface region. This arrangement may allow for the creation of pressure waves within the composition and/or for causing circulation of the composition, both improving the efficiency of the treatment.

The inventive device allows for treating the respective regions of the dentition simultaneously by means of predetermined mechanical forces (i. e. vibrations) and a cleaning agent (and/or remineralizing composition and/or pharmaceutical composition) at a certain temperature (body temperature) for a certain time (duration of the treatment), whereas—in contrast to toothbrushes, interdental brushes or floss, the matched regions will be treated essentially during the whole duration of the application of the device.

The contour surfaces being formed according to the individual geometry of the patient's dentition ensures that the treatment is as efficient as possible and equally reaches all surfaces to be treated; however, without damaging the surfaces as well as the adjacent gingiva/mucosa seams.

The inventive device, therefore, allows for systematically cleaning the respective teeth/implants as well as the adjacent regions of the gingiva/mucosa, taking account of the individual geometry and situation of these teeth/implants (including artificial teeth or dental restorations as well as implant-supported reconstructions). At the same time, mechanical damage that may occur when using mechanical handheld cleaning devices such as toothbrushes, dental floss or interdental brushes is avoided because the mechanical forces may be precisely adjusted and are not subject to individual handling by the user. A further major advantage of the invention lies in the fact that the sulcus region as well as the transition from an artificial tooth or crown to the implant or the carrying tooth may be thoroughly cleaned, thereby avoiding the formation of plaque in these critical regions.

The inventive device is especially suited to be used by patients having restorations (fillings), reconstructions, crowns or fixed dental prostheses on teeth and/or implants. It may as well be used by qualified personnel such as dental hygienists or nurses. It helps to care for the implant or the tooth carrying the reconstruction/restoration as well as for the surrounding natural tissues, especially in cases where the use of the inventive device starts immediately after insertion of the restoration, reconstructions on teeth or implants. The device allows for a systematic and thorough cleaning of the natural and/or artificial teeth as well as of the adjacent regions of the soft tissues, including the sulcus and reaching into interdental spaces. Employing the inventive device risks for biological failures/complications such as caries, gingivitis, mucositis, periodontitis or periimplantitis are reduced and, therefore, the life-time of the costly dental reconstructions on teeth and/or implants may be substantially increased. The inventive device may complement or even replace traditional cleaning of the dentition such as by means of a toothbrush. The device may be applied for the oral hygiene in handicapped patients needing assistance for cleaning their teeth.

Preferably, the device comprises at least two segments comprising contour surfaces formed according to an individual geometry of the patient's dentition, arranged in such a way that in use both a facial as well as a lingual or palatal surface of a same tooth is simultaneously closely matched. Thereby, all accessible surfaces of the tooth are simultaneously cleaned and interaction of the device with the teeth to be cleaned is improved. Advantageously, the segments are large enough to cover not only the facial as well as the lingual or palatal surfaces but also reach into interdental regions to the adjacent teeth. A device with an alternated one-sided control area may also be constructed.

As mentioned, the composition includes a cleaning agent, a remineralizing composition, and/or a pharmaceutical composition. The cleaning agent may comprise abrasive particles, foaming agents, emulgators etc as well as cosmetic whitening substances. The remineralizing composition may in particular comprise fluorides such as aminfluorides or stannous fluoride. The pharmaceutical compositions may include e. g. anti-inflammatory substances.

The composition may comprise even further agents or compositions, e. g. disinfectants such as chlorhexidine, triclosan, cytl-pyridine-chloride or zinc chloride, natural substances on the basis of tea, oils, basic salt solutions, artificial saliva, etc. It may comprise components having a refreshing effect such as menthol, eucalyptus oil etc. Finally, it may comprise colouring agents, flavouring agents or sparkling agents. Besides cleaning, i.e. destroying the adhering biofilm, bacterial plaque, the composition may have a prophylactic effect such as delaying the generation of new plaque or mineralisation of plaque.

Preferably, the device comprises a support, and the at least one segment is attached to the support by elastic links. This allows for vibrating the segment independent of the support. The support, the segment(s) and the elastic links may be separate components, or two or all the three of them may be integrated into a single component. In the first case, the links may be manufactured from a different material in order to obtain the required elasticity. In both cases the links may have a smaller cross-section than the other elements in order to obtain the required elasticity.

Alternatively, the segment is attached to the support by rigid links or formed integrally with the support.

Advantageously, the at least one segment is individually formed and detachably connected with the support. In this case, the segment is formed based on information on the patient's dentition such as obtained by a dental impression or by 3-dimensional imaging through scanning procedures on dental casts or directly in the patient's mouth. The segment may be manufactured e. g. by casting the dental impression or by CAM methods. The segment will usually be manufactured by a specialist such as a dental technician and attached to a standard support (whereas the latter may be available in different sizes and/or deformable in order to adapt it approximately to the patient's dentition.)

Alternatively, both the segment and the support are custom-made, based on the mentioned information, or the contour surfaces of the segment are only formed during the (first) application of the device as described in more detail below.

Preferably, a vibration generator is connected to the support. This allows for generating vibrations having a predetermined amplitude, frequency as well as vibration plane(s). The vibration generator may be a dedicated device, or the support may be designed in such a way that existing vibration generators such as e. g. those of electrical toothbrushes may be connected.

Advantageously, the vibration generator is detachably connected to the support, in particular by a clip-on mechanism. First of all, this allows for modularly building up the device by combining a suitable support, a suitable vibration generator as well as a customized segment. Furthermore, this allows for easily detaching the vibration generator for cleaning or storage of the device as well as if the support or vibration generator are to be replaced.

Alternatively, the vibration generator is fixedly connected to the support, arranged within a dedicated receptacle of the support or connected by other means such as e. g. a screw connection.

Preferably, the transmission element is formed in such a way that in use the vibration generator is placed outside the patient's mouth. This reduces the space requirements within the mouth of the patient and reduces the demands on the design of the vibration generator, e. g. as regards the material of its outer shell or the encapsulation of electrical leads or an electrical power source such as a battery.

Alternatively, the vibration generator is placed inside the patient's mouth during use. For that purpose it may e. g. be integrated with the support. In that case it may include the vibration generator as well as a rechargeable battery for supplying the motor, whereas the battery may be inductively charged such that the components may be encapsulated within a closed housing, thus ensuring biocompatibility and avoiding bacterial/viral contamination.

In a preferred embodiment, the device comprises an elastic support cushion for supporting the support on a coronal surface of the tooth (or the dental crown, respectively) or of adjacent or opposite teeth. This allows for a more comfortable use of the device by the patient and for a precise placement of the device, thereby improving the reliability of the treatment carried out by using the device.

Alternative embodiments do not have such a cushion and the device is either fixed between the dentition of the lower jaw and the dentition of the upper jaw or clamped onto one of the dentitions. In a further alternative, the support is directly supported on the coronal surface of the tooth or of adjacent or opposite teeth.

Advantageously, the vibration is generated in the at least one segment, whereas a main plane of vibration is substantially perpendicular to a tooth axis, i. e. lying in a vertical plane that extends substantially perpendicular to the dental arch. This allows for an optimum cleaning action.

Alternatively or in addition, vibrations may be generated that lie in other planes.

Advantageously, the vibration frequency is in the range of 10-500 Hz, preferably 25-200 Hz. Using these comparably low frequencies may yield good cleaning results—at the same time these frequencies are much less annoying to the patient than higher acoustic frequencies, which is important in the present case as due to the adaptation of the segment to the individual form of the patient's dentition the vibrations are rather strongly coupled into the patient's jaw. This is different from electrical toothbrushes that often operate at higher vibration frequencies, which however are only weakly coupled into the user's jaw.

During a treatment cycle, the vibration frequency as well as the vibration plane may be varied in order to optimize the result of the treatment.

Preferably, the device comprises a storage for the composition comprising a porous material for absorbing and releasing the composition. By choosing the properties of the porous material as well as of the composition the release of the latter may be controlled.

The device may contain a supply for the composition leading into a region of the contour surface of the at least one segment. This allows for supplying composition according to the needs of the treatment, in particular for supplying a liquid composition. Dosage of the composition may be varied during a treatment cycle or different compositions may be supplied in different phases of a treatment cycle.

Alternatively, the composition is pasty or gel-like such that it adheres to the segment. This allows for omitting the storage and/or the supply.

An arrangement comprising at least two segments allows for these at least two segments acting upon the tooth with a (predetermined) clamping force. This force supports the action of the vibration onto the teeth and gums and ensures that even during vibration there is always a certain minimum force acting onto the surfaces to be treated.

The segment or segments of the inventive device may be designed in such a way that essentially a single natural or artificial tooth or dental restoration, respectively as well as the surrounding gingiva/mucosa is treated. In other embodiments, the segments are formed to match a plurality of adjacent teeth, in particular essentially a whole dentition of the lower jaw and/or of the upper jaw. This allows for efficiently and evenly treating the whole dentition by simultaneously treating all teeth and the accessible areas of the gums (gingiva, mucosa).

Generally, the more teeth that are simultaneously treated the better is the efficiency of the inventive device, which may be illustrated as follows. In average, the critical transition region between the tooth and the gingiva (the “seam”) extends over a length of about 60 cm if all 32 teeth of the patient's mouth are taken into account. Using a toothbrush, only the outer regions are cleaned, their length amounts to about 40 cm. If the patient's dentition is cleaned as usual, using a toothbrush with a head having a length of 2 cm for 3 minutes, every section of the outer regions of the seam is cleaned during at most 3-5 s, assuming that on average only about ⅓ to ½ of the time the toothbrush head contacts the seam. In contrast, if the whole dentition is treated with the inventive device, focusing upon the seam, the duration of the treatment of a given seam region will be higher by a factor of more than 10 if the device is only used for a single minute.

In a preferred embodiment, at least two segments are part of a substantially U-shaped receptacle that substantially encloses a complete dentition of a lower and/or upper jaw. The receptacle may have an H-shape (“double-U-shape) for enclosing the complete dentition.

In an initial state the receptacle may be filled with a ductile material that assumes and retains a form of a tooth's outer surface. This obviates the need for costly custom-made segments, made by a dental technician, but the individually adapted contour surfaces are created only when the device is (first) used. The whole device or the content of the receptacle may be used once or several times before replacement. The composition may be stored within the ductile material for one or several uses, it may be supplied by a supply as mentioned above or it is applied by the user, e. g. in the form of a paste to coat the formed surface. This specific embodiment is of a low cost and allows for wide use by almost anyone, especially by users without dental implants or restorations.

Alternatively, custom-made segments are arranged within the receptacle.

The composition may be comprised in a packaging that is designed in such a way that it is opened by biting onto it by the patient. In this case for every use a new packaging will be placed within a dedicated reception space of the device, e. g. within the U-shaped receptacle mentioned above.

Certain embodiments feature a contact surface for both the dentition of the lower jaw and the dentition of the upper jaw such that the transmission element transmits chewing movements to movements of the contact surface. This obviates the need for a vibration generator and therefore for an external or built-in power supply. Furthermore, it allows for having a low-cost, compact and simple embodiment of the invention, in particular in connection with the self adapting ductile material mentioned before.

In a preferred embodiment, the inventive device comprises
a) an actuator module generating the vibrations,
b) a treatment head comprising the at least one segment comprising the contour surface formed according to an individual geometry of a patient's dentition, and
c) a bite bridge being formed to be held between the teeth of the lower jaw and the teeth of the upper jaw of the patient,
   whereas the actuator module, the treatment head and the bite bridge may be mechanically coupled, in such a way that the vibrations are transmitted from the actuator module to the at least one segment of the treatment head.

The modular construction allows for an easy adaptation of the device to the dentition of the patient. The at least one segment itself may be removable from the treatment head such that the modularity is further enhanced.

Other advantageous embodiments and combinations of features come out from the detailed description below and the totality of the claims.

### BRIEF DESCRIPTION OF THE DRAWINGS

The drawings used to explain the embodiments show:

FIG. 1 a cross section through a first embodiment of an inventive device;

FIG. 2 a cross section through a second embodiment of an inventive device;

FIG. 3 cross sections and an isometric view of a third embodiment of an inventive device; and

FIGS. 4.1-4.10 schematical representations of a fourth embodiment of an inventive device.

In the figures, the same components are given the same reference symbols.

### PREFERRED EMBODIMENTS

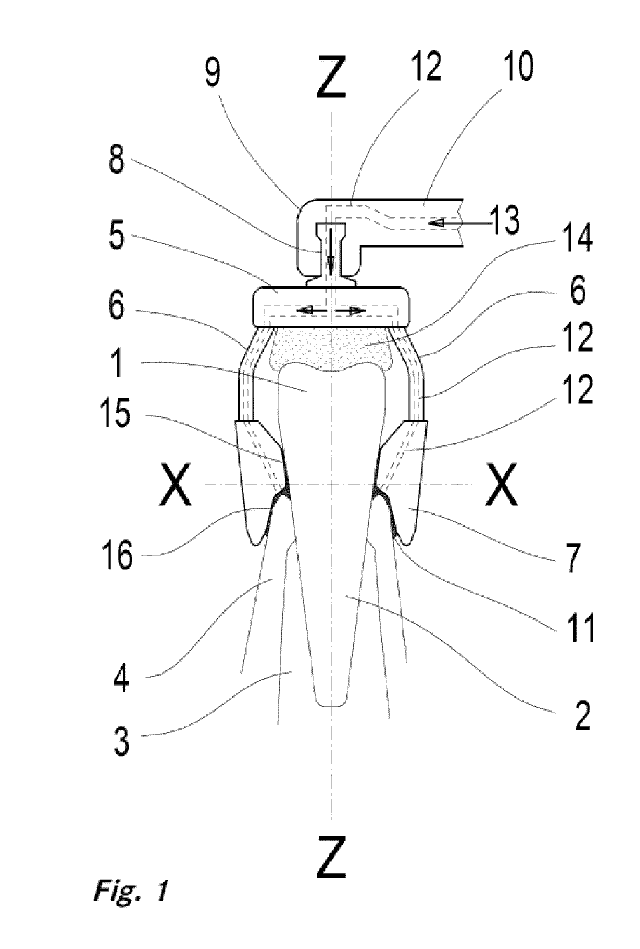

FIG. 1 shows a cross section through a first embodiment of an inventive device. The shown cross section runs through a healthy tooth from lingual to facial side of the tooth. The shown device may cover a number of adjacent teeth, whereas the situation at every tooth essentially corresponds to the one shown in FIG. 1.

The tooth 1 is schematically shown with its root 2, the jaw-bone 3 and the surrounding gingiva 4. Using the inventive device the tooth and the gingiva, more precisely the transition between the tooth and the gingiva in the region of the horizontal plane X-X, are treated.

The device comprises a basic support 5 which is manufactured from a stable thermoplastic resin (such as polyamide) or from a metal that is appropriate for medical use (such as titanium or stainless steel). Two links 6 are attached to the basic support 5 having a first portion adjacent to the support that extends in an oblique direction with respect to the axis of the tooth as well as a second portion attached to the first portion that extends substantially parallel to the axis of the tooth. The second portion ends at about half the height of the part of the tooth protruding from the gingiva 4, lateral to the tooth's lingual and facial surface, respectively. The links 6 are slightly elastic.

At the free end of the second portion of the links 6 formed segments 7 are attached, each of those comprising an inner contour surface that is formed according to the individual geometry of the tooth 1. The segments 7 are attached in such a way that they essentially lie against the respective surfaces of the tooth 1 and the gingiva 4, except for a small gap. The gap may accommodate a pasty or gel-like composition 11 which is applied to the contour surface of the segments 7 before use of the device.

Vibrations are applied to the basic support 5 by means of a coupling pin 8 being fixedly attached to the support 5. A head piece 9 may be clipped onto the coupling pin 9, whereas the head piece 9 is formed unitary with a transmission rod 10. The transmission rod 10 is connected to a vibration generator (not shown) arranged outside the mouth of the user. The vibration generator has a housing having the form of a handgrip. A further quantity of composition 11 used in the treatment may be supplied through a supply channel 13 running within the transmission rod 10, the head piece 9, the coupling pin 8 as well as the basic support 5, the links 6 and the segments 7. The composition 11 may be dosed in a continuous or pulsed manner.

In the embodiment shown in FIG. 1 the segments 7 are formed in such a way that they contact a part of the neck 15 of the tooth 1 as well as of the adjacent gingiva 4, including the sulcus region 16. This allows for massaging and cleaning the transition region by application of the inventive device.

Furthermore, a soft elastic support cushion 14 made of e.g. silicone is attached to the lower side of the basic support 5, facing the tooth 1. The support cushion 14 ensures a defined distance to the tooth 1 and allows for free vibration of the device.

The vibration plane is substantially perpendicular to the tooth axis Z-Z, i. e. transverse to the tooth along the line X-X. Suitable vibration frequencies are 10-500 Hz, preferably 25-200 Hz.

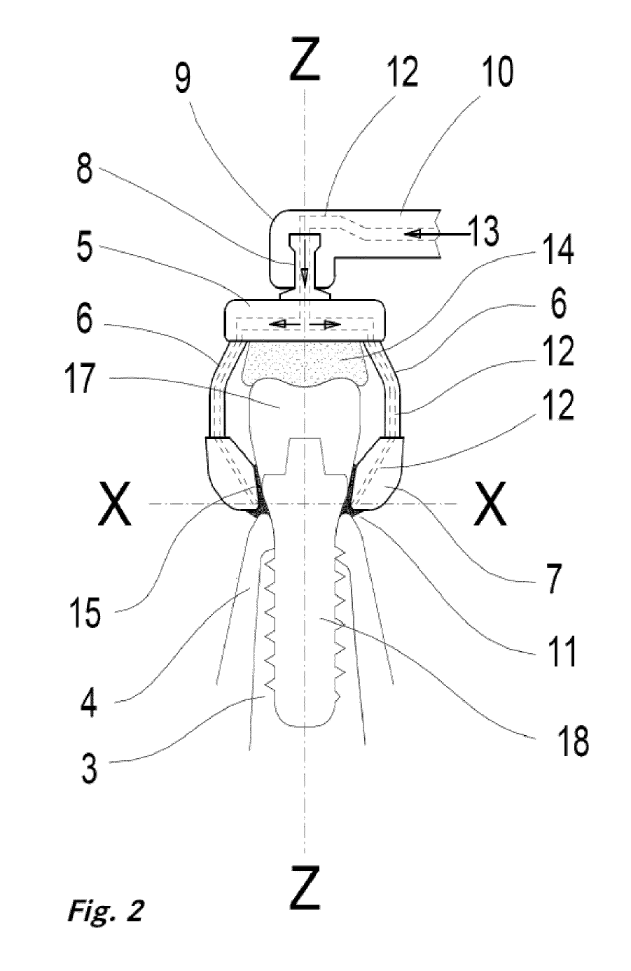

The FIG. 2 shows a cross section through a second embodiment of an inventive device. In contrast to FIG. 1, application of the inventive device to an artificial tooth 17 set on an implant screw 18 is shown. In many aspects, the device corresponds with the one according to the first embodiment described in more detail above, in connection with FIG. 1. The main difference lies in the form of the form segments 7: according to the second embodiment they only cover a part of the neck 15 of the tooth or implant, respectively. As can be seen from FIG. 2, the segments 7 cover the sulcus but essentially no further regions of the gingiva/mucosa 4.

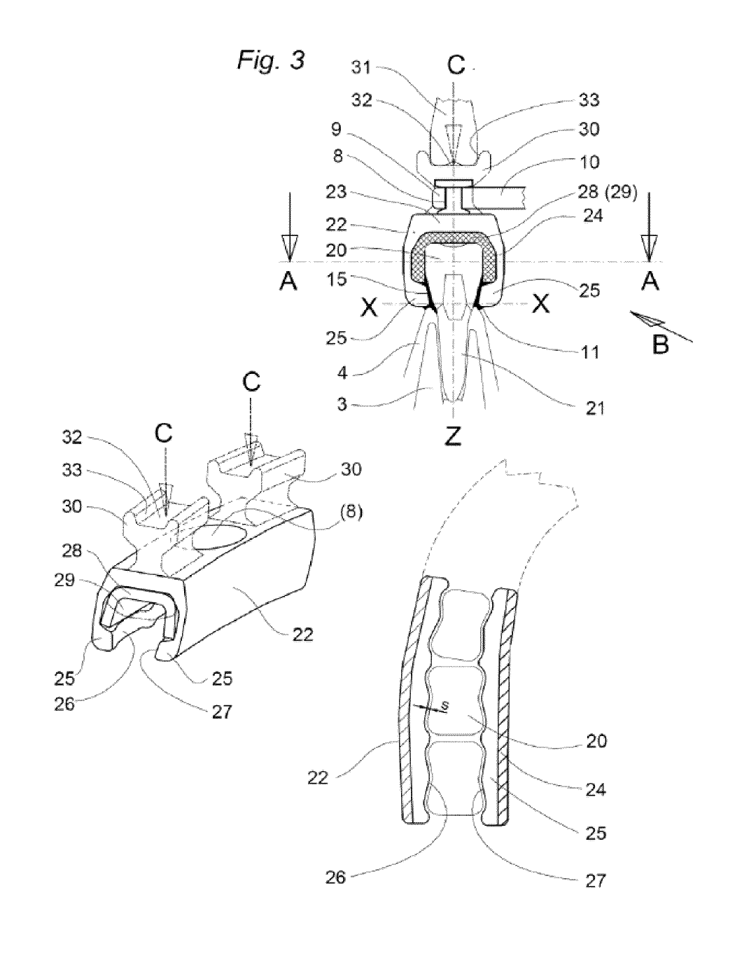

FIG. 3 shows cross sections and an isometric view of a third embodiment of an inventive device. The device is shown in connection with a dental crown 20 cemented onto a natural tooth 21. The figures show a cross section that runs through the tooth and the crown from a lingual to a facial side of the tooth, another cross section in a horizontal plane, i. e. perpendicular to the first cross section, and an isometric view seen from the direction of arrow B.

The device according to the third embodiment comprises a U-shaped shell-like receptacle 22 that may be snapped onto a number of adjacent teeth. The receptacle 22 is made from a thermoplastic resin (such as polyamide, POM, etc.). It consists of a stable basic wall 23 and two side walls 24 that have a smaller cross section and which are attached to the basic wall 23 on both sides. Due to the reduced cross section the side walls 24 are slightly elastic. Both side walls 24 are terminated by a bead 25 directed to the interior. The inner surfaces of the bead 25 feature individually formed contour surfaces 26, 27 according to the individual geometry of the respective part of the crown 20. The segments 7 are attached in such a way that they essentially lie against the respective surfaces of the crown 20, except for a small gap (having a width s). The gap accommodates a pasty or gel-like composition 11.

Before use, a fleece strip 28 being soaked by the composition 11 may be inserted into the receptacle 22, which provides for a sufficient quantity of the composition in the region of the contour surfaces 26, 27 during the whole treatment cycle. The fleece strip is made from a physiologically harmless, natural or synthetic fiber material, preferably from cellulose or cotton fibers or an absorptive open-cell foam material.

On the outer main surface of the basic wall 23 pressure buffers 30 preferably made from a soft silicon rubber or polyurethane may be attached. By pressing onto these buffers 30 by the opposite teeth 31 (in direction C) the composition 11 contained within the strip 28 may be successively pressed out of the strip 28.

In order to stabilize the position of the receptacle 22, in particular against lateral tipping of the receptacle 22 inserted into the mouth the pressure buffers 30 may have a recessed form, comprising recessed pressure surfaces 32 and bilateral support flanks 33, thereby centering the receptacle 22 against the opposite teeth 31 when biting.

In lieu of the strip 28 a capsule 29 may be introduced into the receptacle 22 before use of the device. Before use the capsule 29 is sealed, in particular by a gelatin shell or a cushion-shaped welded foil, e. g. from an edible material (starch) or another physiologically harmless synthetic material (e. g. Polyethylene). The capsule 29 contains a certain volume of medium 11 and has a form that corresponds to the inner space of the receptacle 22. By applying a pressure in direction C by biting with the opposite teeth the capsule is made to burst open and thereby discharges the composition 11 required for the treatment. It is possible to employ the fleece strip 28 as well as the medium filled capsule 29 in the context of the same treatment, either simultaneously or subsequently.

Different methods are applicable for the manufacture of the receptacle 22. In a first variant, prefabricated blanks having thick beads 25 may be employed, the contour surfaces 26, 27 being created by suitable material removing methods, based on a dental impression or on scanned 3d data. Suitable methods comprise 3d milling or grinding as used in known CAD/CAM applications in dentistry.

In a second variant complete receptacles 22 are manufactured in a single operation based on the mentioned information by “rapid prototyping” methods such as 3d printing, laser sintering or stereo lithography.

A third variant is much simpler and may be carried out by the dentist, the dental technician or even the user himself or herself, without the need for expensive technologies. For that purpose an impression mass is used that is known per se in the field of dentistry, e. g. an addition-curing or condensation-curing silicone, polyvinylsiloxane or polyether. The mass is filled into a receptacle similar to that shown in FIG. 3, having a slightly larger interior space for accommodating the mass. The form of the teeth (or crowns) is cast using this mass by applying the receptacle 22 onto the teeth and applying pressure by the opposite row of teeth. After a certain hardening of the mass the geometry thus created is available for further uses.

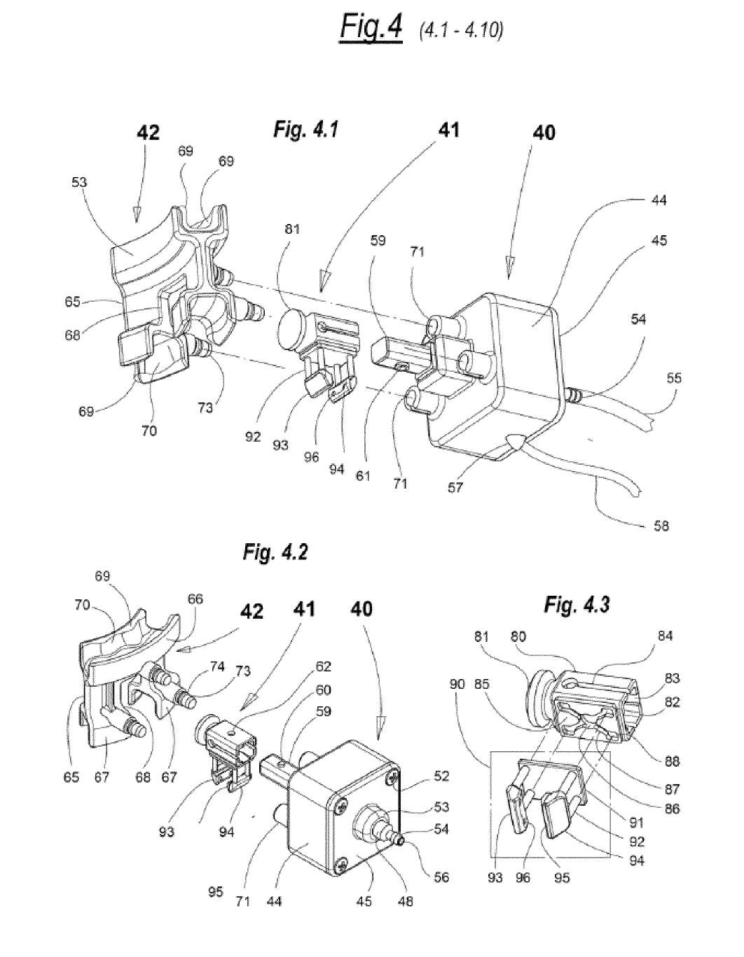

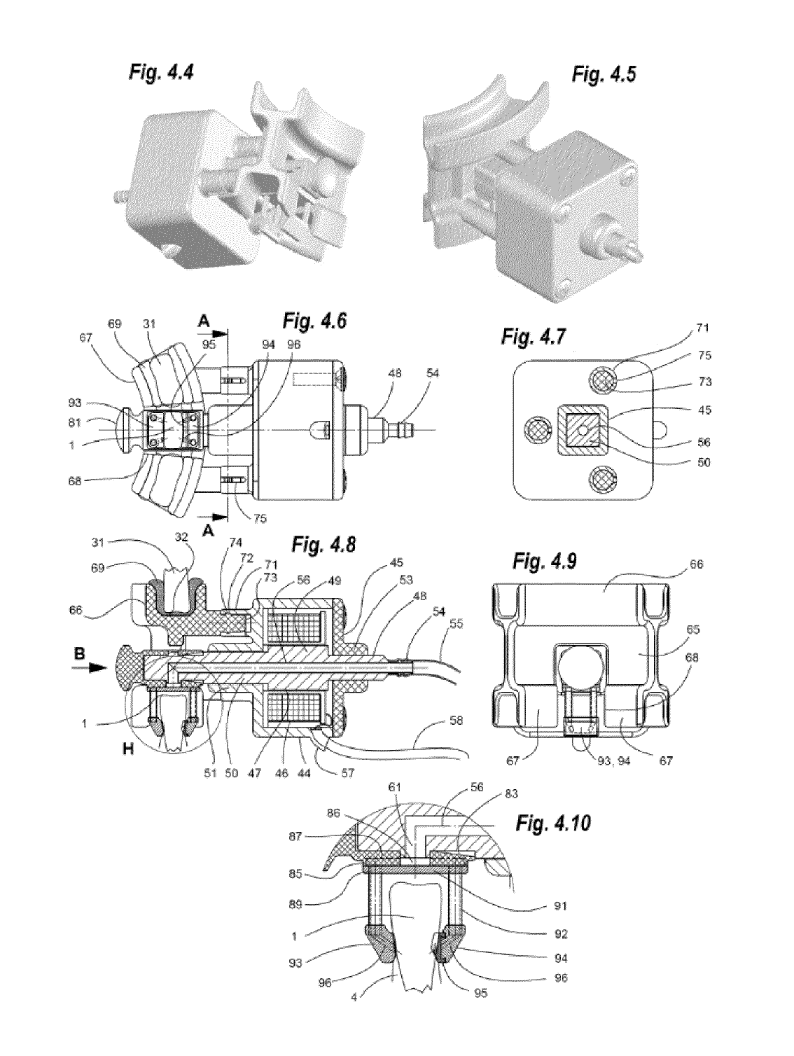

The FIGS. 4.1-4.10 are schematical representations of a fourth embodiment of an inventive device. This embodiment is a modular application unit with an optional vibration actuator, for specific treatment of single teeth, in particular teeth of the frontal region of the dentition. The modular application unit uses the same active principles as the embodiments described above.

FIGS. 4.1 and 4.2 are partly exploded views showing the three main components, namely the actuator module 40, the treatment head 41 and the bite bridge 42. The FIG. 4.3 is a further partly exploded view of the treatment head 41. FIGS. 4.4, 4.5 show the application unit in the assembled configuration. The FIG. 4.6 is a top view of the application unit, the FIG. 4.7 is a cross sectional view along A-A of FIG. 4.6. The FIG. 4.8 is another cross-sectional view of the unit, in a plane running through the tooth from a lingual to a facial side of the tooth. The FIG. 4.9 is a frontal view of the unit. Finally, FIG. 4.10 is an enlarged view of the marked region of FIG. 4.8.

The three main components (or modules) 40, 41, 42 may be easily assembled for use or disassembled for cleaning. For that purpose the components comprise link and interface elements, respectively. Furthermore, professionals may carry out individual modifications of the form of the treatment head 41 and the bite bridge 42 using suitable materials and procedures.

The actuator module 40 of the fourth embodiment comprises a vibration generator based on an oscillating electromagnetic armature (other principles known as such may be employed such as a motor connected to a rotating excentric mass or a piezo vibration drive). An electromagnetic coil 46 (schematically represented in FIG. 4.7) is arranged within a housing 44 with a lid 45. A central oscillation shaft 48 having a section 49 constituting the oscillating armature is arranged within the bore 47 of the coil. On the front side (treatment side), the shaft 48 has a square cross section and is guided through a bearing region 51 formed at the housing 44, such that the shaft 48 is guided within the housing for axial vibrational movements, but secured against rotation. On the opposite side of the housing 44, i. e. on the back side, the lid 45 is fitted to the housing 44 and attached by a number of screws 52. The lid 45 comprises a section 53 which serves as a bearing guide for the shaft 48.

The back end of the shaft 48 is designed for attachment of a hose 55, namely as a plug-in sleeve 54. The shaft 48 has a central bore 56 coaxially extending from the plug-in sleeve to the front end of the shaft 48. Using the hose 55 and the bore 56 a gel-like treatment medium may be fed from an external pressure generator (not displayed) to the treatment head 41 during treatment.

Using a cable insertion sleeve 57 integrated to the housing 44 an electrical cable 58 may be led into the housing 44 and connected to the electromagnetic coil 46. An external control unit (not shown) comprises all components and circuitry required for controlling the actuator module 40, i. e. for switching the vibration generator on or off and for controlling the vibrational energy (current, frequency). The front end of the shaft 48 is a plug-on section 59 and has a square cross section for securing the treatment head 41 plugged onto the shaft 48 against rotation. The treatment head 41 may snap onto one or several cam-locks 60 arranged at the plug-on section 59 according to the principle of a snap-on connection known as such. In the region of the plug-on section 59, the bore 56 of the shaft 48 is connected to the outside by a transverse bore 61 and thereby matches a central bore 86 of the treatment head 41.

The purpose of the bite bridge 42 is affixing the whole application unit to the dentition of the user during the treatment or use process. In principle, the bite bridge 42 consists of a stable base body 65 formed from a plastic material such as polyamide. The base body 65 has a U-shaped arc shell 66 and two partial arc shells 67 arranged on both sides of the tooth to be treated, both neighbouring a central clearance 68. The geometry of the clearance 68 is such that it provides an accommodation for the treatment head 41, whereas it allows for free vibration of the head. The bending (or bending radius) of the arc shells 66, 67 roughly corresponds to the regions of the lower and upper dentition to be covered during use of the application unit. The arc shells 66, 67 are filled with a suitable plastic mass 69 which may be formed by a direct dental impression 70 of the user. The mass 69 may be curable as described above in the context of FIG. 3. This allows for a precise adaptation to the respective sections of the rows of teeth of the user's dentition, and the whole application unit may be affixed to and held by the dentition with a high repetition stability. Alternatively, the arc shells may be formed without using a plastic mass, in particular from solid preforms, by CAD/CAM processes known as such, based on dental profiles that have been previously determined by known scanning methods. In a further alternative, the arc shells may be formed by Rapid Prototyping processes.

The interface of the bite bridge 42 with the actuator module 40 is formed as another plug-on connection. For that purpose, a number of suitably formed holding points are arranged on the housing 44, in the shown embodiment there are three plugin sleeves 71 having inside snap-on grooves. The counterparts, three plugin pegs 73 having snap-on ridges, are formed at corresponding positions of the bite bridge 42. The plugin sleeves have longitudinal slits 75 allowing for an increased elastic travel and therefore for an increased axial overlap of the plugin sleeves 71 and the plugin pegs 73.

The treatment head 41 is a snap-on module that may be prepared for treatment of a predetermined specific area of 1 to 2 teeth. For that purpose, standardized basic elements are provided with form segments that are specifically adapted to the seam region to be treated. All standardized basic elements may be provided in a number of basic sizes. The base body 80 of the treatment head 41 is made from a stable and tough but elastic plastic material such as polyamide. A grip knob 81 axially extends from the front side of the base body 80. The form of the grip knob 81 is ergonomically chosen such that it may be easily gripped by two fingers. The back side of the treatment head 41 features an opening 82 which matches the plug-on section 59 of the shaft 48 of the actuator module 40. Notches 62 are arranged on the lateral surfaces delimiting the opening 82. Therefore, the treatment head 41 may be plugged onto the vibrating shaft 48, whereas the notches 62 snap onto the cam-locks 60 such that the treatment head 41 is axially fixed to the shaft 48.

For sliding the opening 82 over the plug-on section 59 of the shaft 48 axial insertion grooves 83 for accommodating the cam-locks 60 are formed in the treatment head, whereas the depth of the insertion grooves decreases from the mouth of the opening 82 to the notches 62 in order to build a lead-in surface. Furthermore, one or two lateral walls feature longitudinal slits 84 allowing for an increased elastic travel. The basic surface of the base body 80 facing the treatment region is a flange surface with increased wall thickness. The corresponding wall has a central bore 86 through which the treatment medium may be supplied from the transversal bore 61 of the plug-on section 59 of the shaft 48 to the treatment head 41. Distribution channels 87 are arranged in the flange surface in a groove-like fashion, they lead from the central bore 86 radially outward to exterior pockets 88. A form segment holder 90 is affixed to the flange surface of the base body 80 by means of a flange countersurface 91. Different fixation methods may be used, such as adhering, ultrasonic welding, laser welding etc., depending from the materials used for the two flange surfaces. After fixation, the flange countersurface 91 seals the distribution channels 87 against the exterior.

Four hollow struts 92 extend into holes 89 of the flange countersurface 91 and are fixedly attached to the flange countersurface 91 (e. g. by adhering or welding). The treatment medium may be supplied from the distribution channels 86 to the form segments through these hollow struts 92. The hollow struts consist of a slightly elastic plastic material (such as a PTFE compound). Due to the fact that the size of the pockets 88 is larger than the diameter of the hollow struts 92, different distances between opposing struts 92 may be realized without having to change the geometry of the distribution channels 87.

Two form segments corresponding to the elements described above in connection with FIGS. 1 and 2 are fixedly attached to two hollow struts 92 each. One of the shown form segments 93 is a unitary individually formed piece. The other form segment 95 is a replaceable part, formed individually e. g. by a CAD/CAM process, which may be attached to a segment base body 94 using a suitable connection. This two-piece embodiment has the advantage that a standardized base body 94 may be fixedly mounted to the whole group of elements 90, and only the form segment 95 needs to be individually adapted using suitable methods. The form segments 93, 95 feature slanted transversal bores 96 which supply the treatment medium from the hollow struts to the desired contact point in the region of the seam to be treated. Optionally, the form segments 93, 95 may consist from an slightly porous elastic material such that the treatment medium may be distributed to the contact surface without any bores 96.

The invention is not restricted to the embodiments described above. In a further embodiment, the vibration generator may be integrated with the support; it may e. g. include an electric motor driving an excentric as well as a rechargeable battery for supplying the motor, whereas the battery may be inductively charged such that the components may be encapsulated within a tube-like closed housing, preferably made from a biocompatible polymer. Thereby, the need for components that are external to the patient's mouth during use of the device may be avoided.

Furthermore, the geometry of the whole device, the segments, the contour surfaces or the receptacle may be widely adapted. Features of the three embodiments may be differently combined. As an example, the embodiment as shown in FIG. 3 may be supplemented by a controllable supply for the cleaning composition.

In summary, it is to be noted that the invention creates a device that allows for the easy and systematic treatment of gingiva/mucosa and natural and/or artificial teeth leading to satisfactory cleaning results.

1. A device for treating gingiva/mucosa and natural and/or artificial teeth, comprising
a) at least one segment comprising a contour surface formed according to an individual geometry of a patient's dentition for closely matching a region of an outer surface of a tooth and an adjacent region of a gingiva or mucosa, whereas the regions include a sulcus region;
b) a storage and/or supply for a composition including a cleaning agent, a remineralizing composition, and/or a pharmaceutical composition to be applied to the regions of the tooth and the gingiva/mucosa;
c) a transmission element for transmitting vibrations to the at least one segment.

2. The device as recited in claim 1, comprising at least two segments comprising contour surfaces formed according to an individual geometry of the patient's dentition, arranged in such a way that in use both a facial as well as a lingual or palatal surface of a same tooth is simultaneously closely matched.

3. The device as recited in claim 2, comprising a support, wherein the at least two segments are attached to the support by elastic links.

4. The device as recited in claim 3, wherein an individually formed segment is detachably connected with the support.

5. The device as recited in claim 3, wherein a vibration generator connected to the support.

6. The device as recited in claim 5, wherein the vibration generator is detachably connected to the support, in particular by a clip-on mechanism.

7. The device as recited in claim 5, wherein the transmission element is formed in such a way that in use the vibration generator is placed outside the patient's mouth.

8. The device as recited in claim 3, comprising an elastic support cushion for supporting the support on a coronal surface of the tooth or of adjacent or opposite teeth.

9. The device as recited in claim 1, wherein a vibration is generated in the at least one segment, and a main plane of vibration is substantially perpendicular to a tooth axis.

10. The device as recited in claim 1, wherein a vibration frequency of the vibrations is in the range of 10-500 Hz, preferably 25-200 Hz.

11. The device as recited in claim 1, wherein the storage for the composition comprises a porous material for absorbing and releasing the composition.

12. The device as recited in claim 1, wherein the supply for the composition leads into a region of the contour surface of the at least one segment.

13. The device as recited in claim 1, wherein the composition is pasty or gel-like.

14. The device as recited in claim 1, wherein the composition comprises abrasive particles.

15. The device as recited in claim 2, wherein the at least two segments act upon the tooth with a clamping force.

16. The device as recited in claim 2, wherein the at least two segments are formed to match a plurality of adjacent teeth, in particular essentially a whole dentition of the lower jaw or of the upper jaw.

17. The device as recited in claim 16, wherein the at least two segments are part of a substantially U-shaped receptacle that substantially encloses a complete dentition of a lower and/or upper jaw.

18. The device as recited in claim 17, wherein in an initial state the receptacle is filled with a ductile material that assumes and retains a form of a tooth's outer surface.

19. The device as recited in claim 1, wherein the composition is comprised in a packaging that is designed in such a way that it is opened by biting onto it by the patient.

20. The device as recited in claim 16, wherein a contact surface for both the dentition of the lower jaw and the dentition of the upper jaw such that the transmission element transmits chewing movements to movements of the contact surface.

21. The device as recited in claim 1, comprising
a) an actuator module generating the vibrations,
b) a treatment head comprising the at least one segment comprising the contour surface formed according to an individual geometry of a patient's dentition, and
c) a bite bridge being formed to be held between the teeth of a lower jaw and the teeth of an upper jaw of the patient,
whereas the actuator module, the treatment head and the bite bridge may be mechanically coupled, in such a way that the vibrations are transmitted from the actuator module to the at least one segment of the treatment head. Preliminary Amendment
